(19) United States
(12) Patent Application Publication
(10) Pub. No.: US 2015/0321485 A1
(43) Pub. Date: Nov. 12, 2015

(54) PRINTING APPARATUS

(71) Applicant: HEWLETT-PACKARD DEVELOPMENT COMPANY ,L.P., Houston, TX (US)

(72) Inventors: Emilio José Góngora Cañada, Sant Cugat del Valles (ES); Elena Laso Plaza, Barcelona (ES); Antonio Monclus Velasco, Castelldefels (ES); Francisco Javier Rodriguez Escañuela, Mataro (ES); Xavier Soler Pedemonte, Barcelona (ES)

(73) Assignee: HEWLETT-PACKARD DEVELOPMENT COMPANY, L.P., Houston, TX (US)

(21) Appl. No.: 14/410,032

(22) PCT Filed: Jul. 20, 2012
(86) PCT No.: PCT/EP2012/064348

§ 371 Date: Dec. 19, 2014

(51) Int. Cl. B41J 2/335

(52) U.S. Cl. CPC B41J 2/335

(57) ABSTRACT

Printing apparatus (10) including a controller (12) to control supply of at least a first predetermined amount of power to a first heater (18) while the first heater is moving through a print zone (40), and to control supply of at least a second predetermined amount of power to the first heater (18) while the first heater is outside of the print zone (38), the second predetermined amount of power being less than the first predetermined amount of power.

### BACKGROUND

Printing apparatus, such as ink jet printers, usually include a moveable printer carriage that includes at least one print head for depositing ink on a printing media such as paper. The ink usually includes water and consequently, the ink may bleed and coalesce after being deposited on the printing media.

### BRIEF DESCRIPTION

Reference will now be made by way of example only to the accompanying drawings in which:

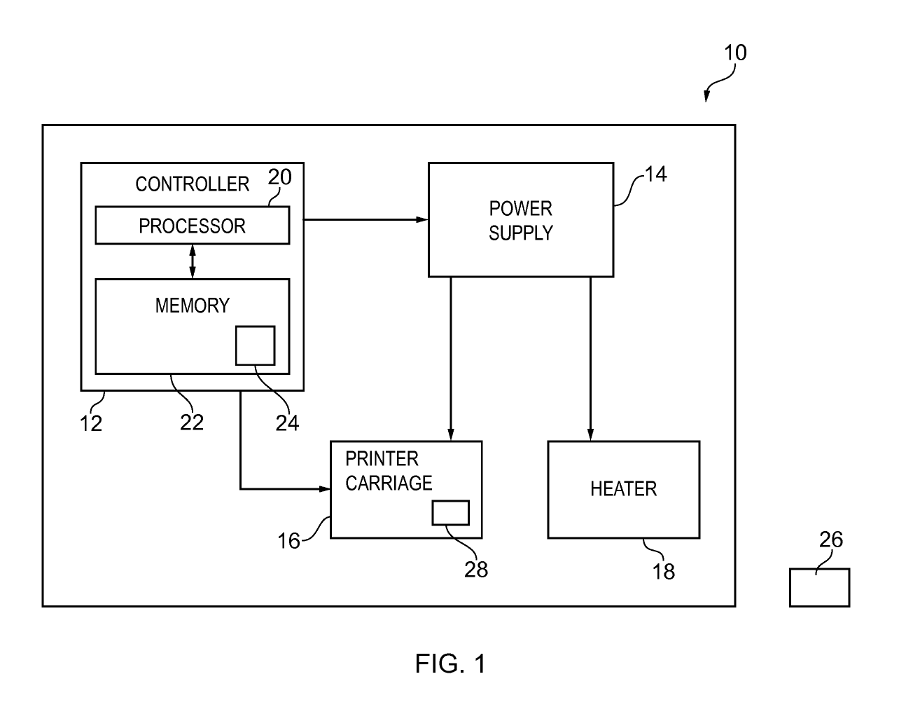

FIG. 1 illustrates a schematic diagram of a printing apparatus according to an example;

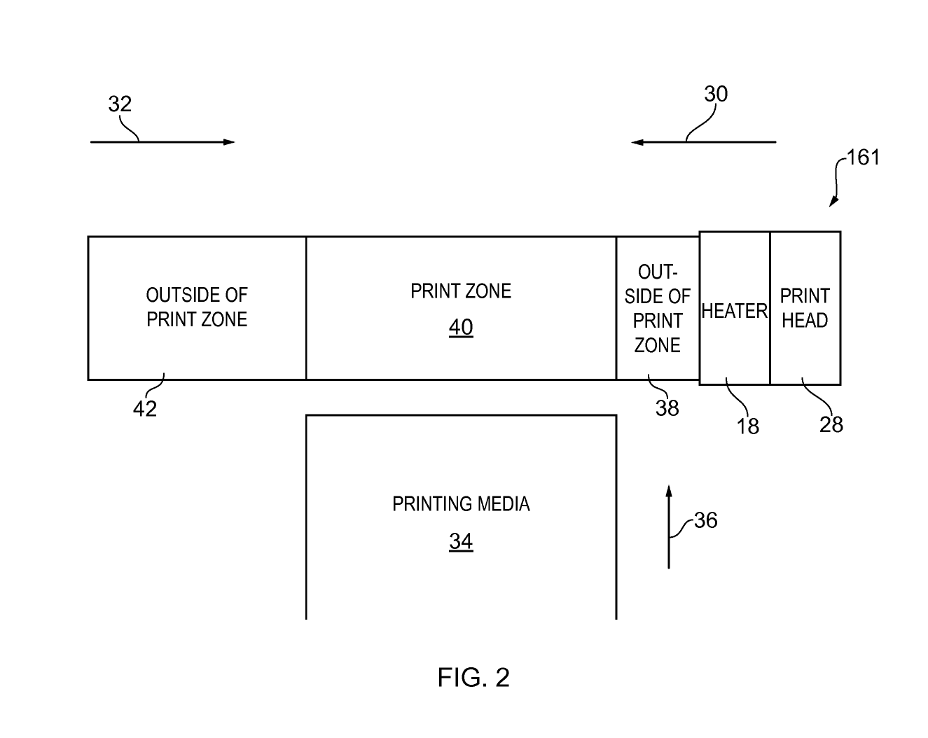

FIG. 2 illustrates a schematic plan view diagram of a printer carriage in use according to an example;

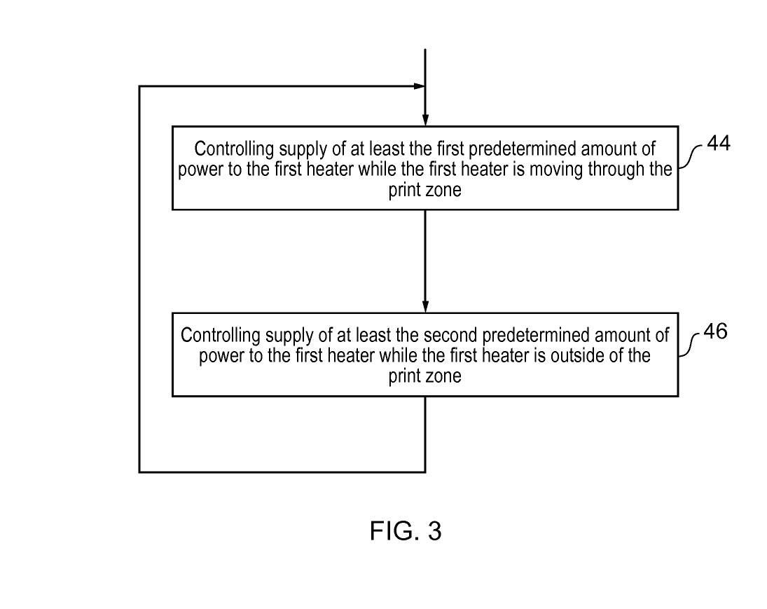

FIG. 3 illustrates a flow diagram of a method of operation for the printer carriage illustrated in FIG. 2;

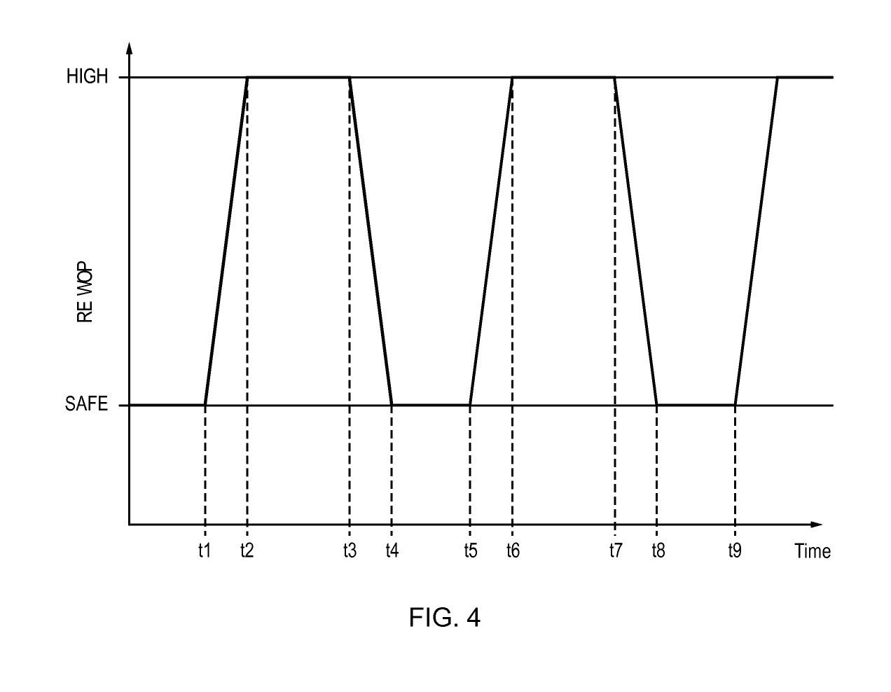

FIG. 4 illustrates a graph of power supply versus time for the printing apparatus according to an example;

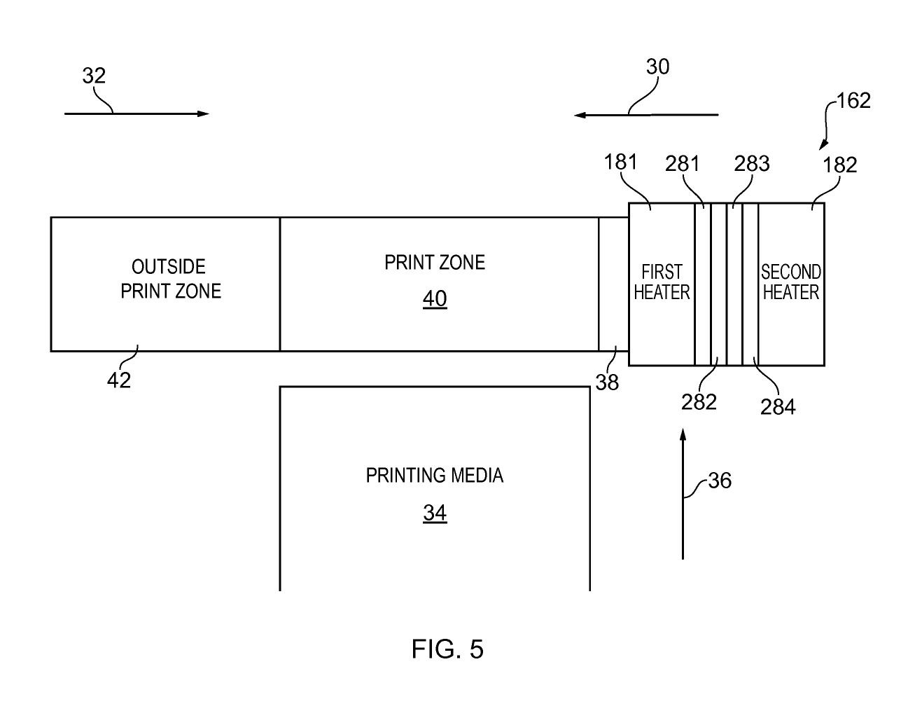

FIG. 5 illustrates a plan view diagram of another printer carriage in use according to an example;

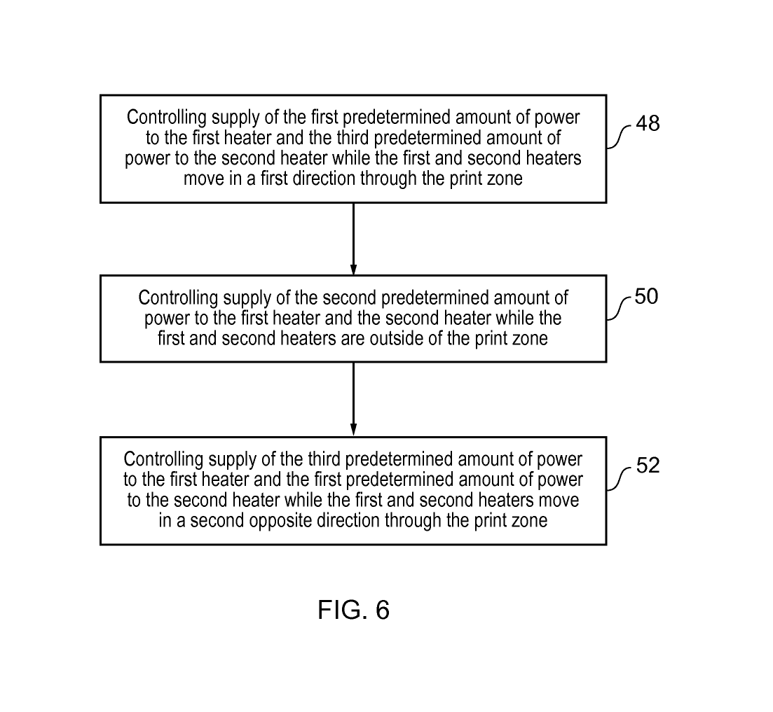

FIG. 6 illustrates a flow diagram of a method of operation for the printer carriage illustrated in FIG. 5;

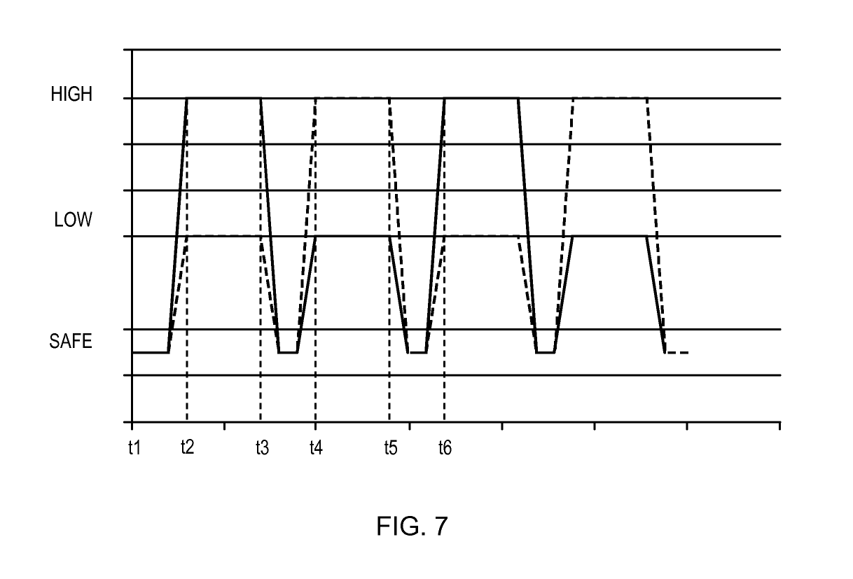

FIG. 7 illustrates a graph of power supply versus time for the printing apparatus according to another example;

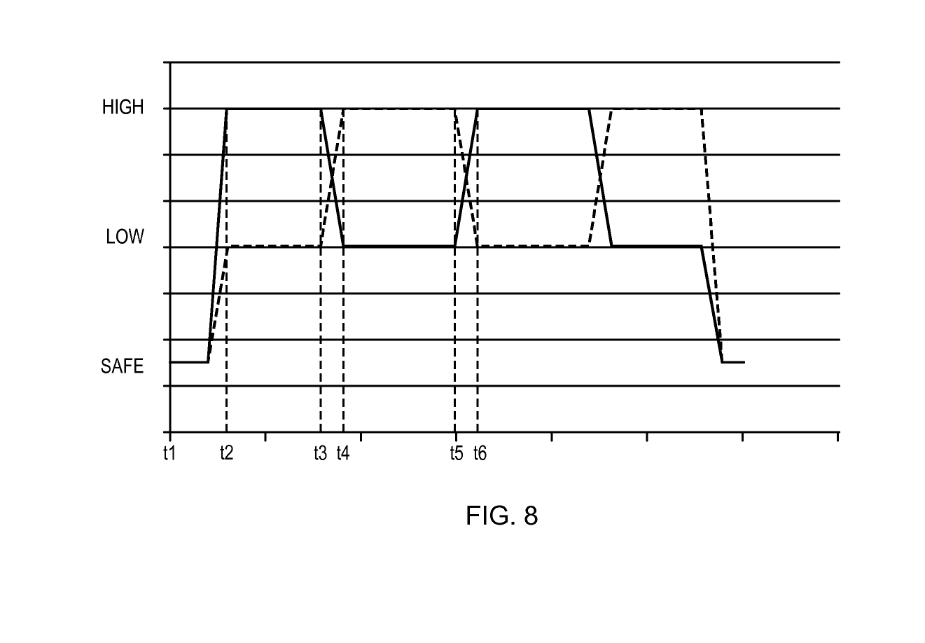

FIG. 8 illustrates a graph of power supply versus time for the printing apparatus according to a further example; and

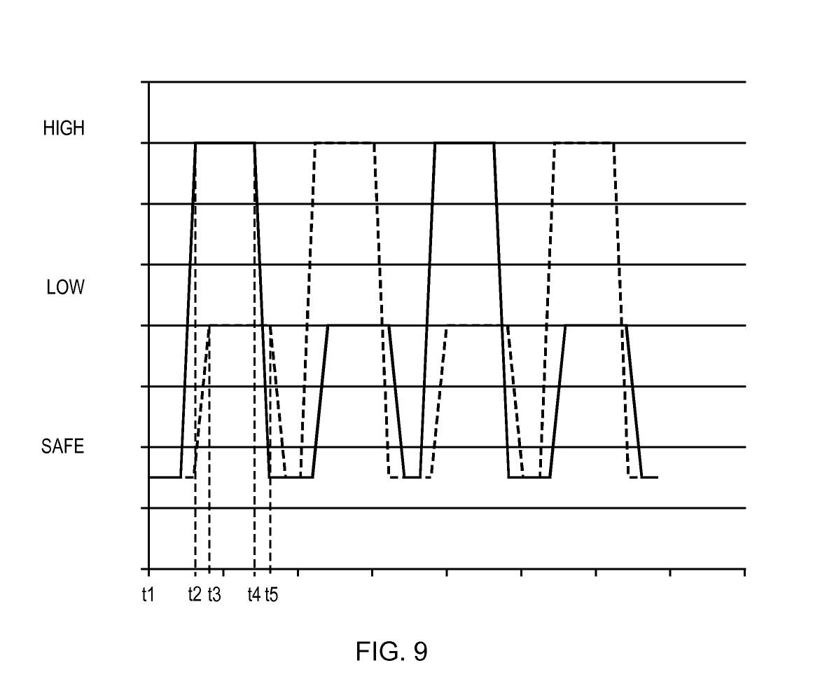

FIG. 9 illustrates a graph of power supply versus time for the printing apparatus according to another example.

### DETAILED DESCRIPTION

In the following description and figures, the wording ‘connect’ and ‘couple’ and their derivatives mean operationally connected or coupled. It should be appreciated that any number or combination of intervening components can exist (including no intervening components).

FIG. 1 illustrates a schematic diagram of a printing apparatus 10 including a controller 12, a power supply 14, a printer carriage 16 and at least one heater 18. The printing apparatus 10 may be any suitable apparatus for depositing ink on a printing media and may be an inkjet printer for example.

The implementation of the controller 12 can be in hardware alone (for example, a circuit, a processor and so on), have certain aspects in software including firmware alone or can be a combination of hardware and software (including firmware).

The controller 12 may be implemented using instructions that enable hardware functionality, for example, by using executable computer program instructions in a general-purpose or special-purpose processor 20 that may be stored on a computer readable storage medium 22 (disk, memory etc) to be executed by such a processor 20.

The processor 20 is configured to read from and write to the memory 22. The processor 20 may also comprise an output interface via which data and/or commands are output by the processor 20 and an input interface via which data and/or commands are input to the processor 20.

The memory 22 stores a computer program 24 comprising computer program instructions that control the operation of the printing apparatus 10 when loaded into the processor 20. The computer program instructions 24 provide the logic and routines that enables the printing apparatus 10 to perform the methods illustrated in FIGS. 3 and 6. The processor 20 by reading the memory 22 is able to load and execute the computer program 24.

The computer program 24 may arrive at the printing apparatus 10 via any suitable delivery mechanism 26. The delivery mechanism 26 may be, for example, a non-transitory computer-readable storage medium, a computer program product, a memory device, a record medium such as a compact disc read-only memory (CD-ROM) or digital versatile disc (DVD), an article of manufacture that tangibly embodies the computer program 24. The delivery mechanism 26 may be a signal configured to reliably transfer the computer program 24. The printing apparatus 10 may propagate or transmit the computer program 24 as a computer data signal.

Although the memory 22 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a) hardware-only circuit implementations (such as implementations in only analogue and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware.

The power supply 14 may be any suitable power supply for supplying electrical power to the components of the printing apparatus 10 (such as the printer carriage 16 and the heater 18). For example, the power supply 14 may be a ‘mains’ power supply or may be an electrical energy storage device such as an electrochemical cell or an electric double layer capacitor (also referred to as a supercapacitor). The controller 12 is arranged to control the power supplied by the power supply 14 to the components of the printing apparatus 10. For example, the controller 12 is arranged to control the power supplied by the power supply 14 to the heater 18.

The printer carriage 16 includes at least one print head 28 (comprising a black, white, coloured or transparent ink for example) and is arranged to move within the printing apparatus 10 in order to enable ink to be deposited across a printing media. The printer carriage 16 is arranged to receive electrical power from the power supply 14, and the controller 12 is arranged to control the operation (including movement and deposition of ink) of the printer carriage 16.

The at least one heater 18 may be any suitable device for emitting thermal energy and may include a high power infra-red radiation source such as a thermal lamp or a laser for example. The heater 18 is arranged to receive electrical power from the power supply 14 and use the electrical power to emit thermal energy. In some examples, the heater 18 is mounted on the printer carriage 16 and is therefore moveable with the printer carriage 16. In other examples, the heater 18 is separate to the printer carriage 16 and the controller 12 is arranged to control the movement of the heater 18 separately to the printer carriage 16.

The operation of the printing apparatus 10 according to an example is described in the following paragraphs with reference to FIGS. 1 to 4.

FIG. 2 illustrates a schematic plan view diagram of a printer carriage 161 in use according to an example. The printer carriage 161 includes a print head 28 and a heater 18 positioned adjacent one another. The controller 12 is arranged to control the movement of the printer carriage 161 in a first direction 30 (horizontally left as illustrated in FIG. 2) and in a second direction 32 (horizontally right as illustrated in FIG. 2).

The printing apparatus 10 is arranged to move printing media 34 (a sheet of paper for example) towards and under the printer carriage 161 (vertically upwards as indicated by the arrow 36 in FIG. 2). For example, the printing apparatus 10 may include a plurality of rollers (not illustrated) for guiding and moving the printing media 34 through the printing apparatus 10.

In operation, the printer carriage 161 may move through a first zone 38, a second (print) zone 40 and a third zone 42. The second (print) zone 40 is an area where the printer carriage 161 may deposit ink on the printing media 34 and has a width that is equal to, or less than, the width of the printing media 34. The first zone 38 is positioned outside of the second (print) zone 40 (on the left as illustrated in FIG. 2) and is an area where the printer carriage 161 should not deposit ink. The third zone 42 is positioned outside of the second (print) zone 40 (on the right as illustrated in FIG. 2) and also is an area where the printer carriage 161 should not deposit ink. In some examples, the first and third zones 38, 42 may be outside the edges of the printing media 34 (as illustrated in FIG. 2) or may include margins of the printing media 34 that are not to receive ink. The sizes of the first, second and third zones 38, 40, 42 may not be fixed and may vary depending on the dimensions of the printing media 34.

With reference to FIG. 3, at block 44, the controller 12 controls the printer carriage 161 to move in the first direction 30 and into the print zone 40. As the heater 18 enters and moves through the print zone 40, the controller 12 controls the power supply 14 to supply a first predetermined amount of power to the heater 18 so that the heater 18 has a first thermal energy output.

As illustrated in FIG. 4, at time t1, the heater 18 is moved in proximity to the print zone 40 and the controller 12 controls the power supply 14 to increase the power supplied to the heater 18 from a second (safe) predetermined amount of power to the first (high) predetermined amount of power. At time t2, the increase in power supply plateaus and the heater 18 enters the print zone 40 and receives the first (high) predetermined amount of power from the power supply 14. The heater 18 receives the first (high) predetermined amount of power as it moves through the print zone 40 between times t2 and t3.

While the printer carriage 161 moves through the print zone 40 in the first direction 30, the heater 18 provides thermal energy to the printing media 34 to heat the printing media 34. Additionally, the print head 28 deposits ink on the heated printing media 34 to form text and/or images on the printing media 34. It should be appreciated that thermal energy transfers from the heated printing media 34 to the deposited ink causing the deposited ink to dry and thereby reduces bleeding and coalescence of the ink on the printing media 34. The first predetermined amount of power is selected so that the printing media 34 transfers sufficient heat to the deposited ink to dry the ink as desired.

At block 46, the controller 12 controls the printer carriage 161 to move into the third zone 42. As the heater 18 enters and moves through the third zone 42, the controller 12 controls the power supply 14 to supply a second (safe) predetermined amount of power to the heater 18 so that the heater 18 has a second thermal energy output. The second predetermined amount of power is less than the first predetermined amount of power and consequently, the second thermal energy output is less than the first thermal energy output.

The second predetermined amount of power is selected so that heat energy from the heater 18 causes little or no damage to the printing apparatus or any harm to a body part of a user of the printing apparatus 10. In some examples, the second predetermined amount of power may be zero.

In more detail, at time t3, the heater 18 is moved outside of the print zone 40 and into the third zone 42 and the controller 12 controls the power supply 14 to decrease the power supplied to the heater 18 from the first (high) predetermined amount of power to the second (safe) predetermined amount of power. At time t4, the decrease in power supply plateaus and the heater 18 receives the second (safe) predetermined amount of power from the power supply 14. The heater 18 receives the second (safe) predetermined amount of power as it moves through the third zone 42 in the first direction 30 and returns in the second direction between times t4 and t5.

The method then returns to block 44, and at time t5, the heater 18 is moved in the second direction 32 in proximity to the print zone 40 and the controller 12 controls the power supply 14 to increase the power supplied to the heater 18 from the second (safe) predetermined amount of power to the first (high) predetermined amount of power. At time t6, the increase in power supply plateaus and the heater 18 enters the print zone 40 and receives the first (high) predetermined amount of power from the power supply 14. The heater 18 receives the first (high) predetermined amount of power as it moves through the print zone 40 in the second direction 32 between times t6 and t7.

While the printer carriage 161 moves through the print zone 40 in the second direction 30, the heater 18 provides thermal energy to the printing media 34 to heat the printing media 34 and the previously deposited ink.

At time t7, the heater 18 is moved outside of the print zone 40 in the second direction 42 and into the first zone 38. The controller 12 controls the power supply 14 to decrease the power supplied to the heater 18 from the first (high) predetermined amount of power to the second (safe) predetermined amount of power. At time t8, the decrease in power supply plateaus and the heater 18 receives the second (safe) predetermined amount of power from the power supply 14. The heater 18 receives the second (safe) predetermined amount of power as it moves through the first zone 38 in the second direction 32 and the first direction 30 between times t8 and t9.

The heater 18 may subsequently repeat the above described method so that the actions performed between times t1 and t9 are repeated from time t9 onwards for a new area on the printing media 34 (i.e. the printing media 34 is moved incrementally in direction 36 between times t8 and t9 for repeats of the above described method).

The printing apparatus 10 provides an advantage in that a first relatively high power level is supplied to the heater 18 while the heater 18 is over the print zone 40, and a second relatively low power level is supplied to the heater 18 while the heater 18 is outside of the print zone 40. This may help to reduce the electrical energy consumption of the printing apparatus 10 which may reduce the operating costs of the printing apparatus 10.

Furthermore, since the power level supplied to the heater 18 outside of the print zone 40 is relatively low, the thermal energy output by the heater 18 may not damage or degrade components of the printing apparatus 10 (or hurt a body part of a user) that are positioned within the first zone 38 and the third zone 42. Consequently, the printing apparatus 10 may not require protective parts (such as a mechanical shutter) for protecting components of the printing apparatus 10 from the thermal energy emitted by the heater 18 outside of the print zone 40.

The printing apparatus 10 may also be advantageous in that the controller 12 increases and decreases the power supplied to the heater 18 over a period of time (for example, between times t1 and t2 and between times t3 and t4 as illustrated in FIG. 4). This relatively gradual increase and decrease in power supply to the heater 18 may reduce the triggering of over current protection circuitry of the power supply 14 (since large increases and decreases in power supplied provoke overshooting of the electrical current in the heater 18 and hence triggering of the over current protection circuitry). Furthermore, where the second (safe) predetermined amount of power is non-zero, the transition between the first and second predetermined amounts of power is reduced and this may help to reduce the triggering of over current protection circuitry of the power supply 14.

FIG. 5 illustrates a plan view diagram of another printer carriage 162 in use according to an example. FIG. 5 is similar to FIG. 2 and where the features are similar, the same reference numerals are used.

The printer carriage 162 differs from the printer carriage 161 illustrated in FIG. 2 in that the printer carriage 162 includes a first heater 181, a second heater 182, a first print head 281, a second print head 282, a third print head 183 and a fourth print head 184. The first, second, third and fourth print heads 281, 282, 283, 284 are arranged in a horizontal row and are sandwiched by the first heater 181 and the second heater 182 so that the first heater 181 is positioned adjacent the first print head 281 and so that the second heater 182 is positioned adjacent the fourth print head 284.

FIG. 6 illustrates a flow diagram of a method of operation for the printer carriage 162 illustrated in FIG. 5. At block 48, the controller 12 controls the printer carriage 162 to move in the first direction 30 from the first zone 38 to the second (print) zone 40 and also controls the power supply 14 to supply a first (high) predetermined amount of power to the first heater 181 and a third (low) predetermined amount of power to the second heater 182 as the first and second heaters 181, 182 enter the print zone 40. The third predetermined amount of power is less than the first predetermined amount of power.

While the printer carriage 162 is in the print zone 40, the controller 12 may control the print heads 281, 282, 283, 284 to deposit ink on the printing media 34 after it has been heated by the first heater 181 to form text and/or images. The second heater 182 subsequently provides thermal energy to further heat the ink deposited on the printing media 34.

At block 50, the controller 12 controls the printer carriage 162 to move in the first direction 30 from the print zone 40 to the third zone 42 and also controls the power supply 14 to supply a second (safe) predetermined amount of power to the first heater 181 and to the second heater 182. The second (safe) predetermined amount of power is less than the first (high) predetermined amount of power and less than the third (low) predetermined amount of power. The controller 12 may also control movement of the printing media 34 in the direction of arrow 34.

At block 52, the controller 12 controls the printer carriage 162 to move in the second direction 32 from the third zone 42 to the print zone 40 and also controls the power supply 14 to supply the third (low) predetermined amount of power to the first heater 181 and to supply the first (high) predetermined amount of power to the second heater 182 as the first and second heaters 181, 182 enter the print zone 40.

While the printer carriage 162 is in the print zone 40, the controller 12 may control the print heads 281, 282, 283, 284 to deposit ink on the printing media 34 after it has been heated by the second heater 182 to form text and/or images. The first heater 181 subsequently provides thermal energy to further heat the ink deposited on the printing media 34.

Subsequently, the controller 12 controls the printer carriage 162 to move in the second direction 32 from the print zone 40 to the first zone 38 and also controls the power supply 14 to supply the second (safe) predetermined amount of power to the first heater 181 and to the second heater 182. The controller 12 also controls movement of the printing media 34 in the direction of arrow 34.

The method may subsequently return to block 48 and be repeated to print a new area of the printing media 34.

The printing apparatus 10 including the printer carriage 162 provides an advantage in that the leading heater may be used to heat the printing media 34 prior to deposition of ink, and the trailing heater may be used to heat the ink deposited on the printing media 34. Consequently, the printer carriage 162 may advantageously heat the printing media 34 prior to deposition of ink in both the first direction 30 and the second direction 32.

FIG. 7 illustrates a graph of power supply for the first heater 181 and the second heater 182 illustrated in FIG. 6 while in operation according to an example. The solid line represents the power supply to the first heater 181 and the dotted line represents the power supply to the second heater 182.

Between times t1 and t2, the first heater 181 and the second heater 182 are outside of the print zone 40 (in the first zone 38) and receive the second (safe) predetermined amount of power. Between times t2 and t3, the first heater 181 and the second heater 182 are in the print zone 40 and the first heater 181 receives the first (high) predetermined amount of power and the second heater 182 receives the third (low) predetermined amount of power. Between times t3 and t4, the first heater 181 and the second heater 182 are outside the print zone 40 (in the third zone 42) and receive the second (safe) predetermined amount of power. Between times t4 and t5, the first and second heaters 181, 182 are in the print zone 40 and the first heater 181 receives the third (low) predetermined amount of power and the second heater 182 receives the first (high) predetermined amount of power. Between times t5 and t6, the first heater 181 and the second heater 182 are outside of the print zone 40 (in the first zone 38) and receive the second (safe) predetermined amount of power.

As illustrated in FIG. 7, the supply of power to the first and second heaters 181, 182 increases and decreases over a period of time (i.e. the power supply is ramped up and down). In some embodiments, the supply of power to the first and second heaters 181, 182 may not be ramped and may be switched between the first, second and third predetermined amounts of power.

FIG. 8 illustrates a graph of power supply for the first heater 181 and the second heater 182 illustrated in FIG. 6 while in operation according to another example. The solid line represents the power supply to the first heater 181 and the dotted line represents the power supply to the second heater 182.

Between times t1 and t2, the first heater 181 and the second heater 182 are outside of the print zone 40 (in the first zone 38) and receive the second (safe) predetermined amount of power. Between times t2 and t3, the first heater 181 and the second heater 182 are in the print zone 40 and the first heater 181 receives the first (high) predetermined amount of power and the second heater 182 receives the third (low) predetermined amount of power. Between times t3 and t4, the first heater 181 and the second heater 182 are outside the print zone 40 (in the third zone 42) and receive decreasing and increasing amounts of power respectively. Between times t4 and t5, the first and second heaters 181, 182 are in the print zone 40 and the first heater 181 receives the third (low) predetermined amount of power and the second heater 182 receives the first (high) predetermined amount of power. Between times t5 and t6, the first heater 181 and the second heater 182 are outside of the print zone 40 (in the first zone 38) and receive increasing and decreasing amounts of power respectively.

The control of the power supply 14 illustrated in FIG. 8 may be used advantageously for relatively fast operating modes where the printer carriage 162 spends relatively little time in the first and third zones 38, 42.

FIG. 9 illustrates a graph of power supply for the first heater 181 and the second heater 182 illustrated in FIG. 6 while in operation according to a furhter example. The solid line represents the power supply to the first heater 181 and the dotted line represents the power supply to the second heater 182. The graph illustrated in FIG. 9 is similar to the graph illustrated in FIG. 7 and differs in that the heaters 181, 182 do not switch at same time. The heaters 181 and 182 operate as independent heaters and when a heater enters or exits the print zone 40, the power is switched. Since the heaters 181, 182 are spaced apart from one another, the switching happens at different times for each heater. This ensures that the heaters 181, 182 independently receive the safe predetermined amount of power when out of the print zone 40.

For example, at time t1, the first heater 181 and the second heater 182 are outside of the print zone 40 (in the first zone 38) and receive the second (safe) predetermined amount of power. At time t2, the first heater 181 enters the print zone 40 and the first heater 181 receives the first (high) predetermined amount of power. At time t3, the second heater 182 enters the print zone 40 and the second heater 182 receives the third (low) predetermined amount of power. At time t4, the first heater 181 exits the print zone 40 (and enters the third zone 42) and receives the second (safe) predetermined amount of power. At time t5, the second heater 182 exits the print zone 40 (and enters the third zone 42) and receives the second (safe) predetermined amount of power.

As illustrated in FIG. 9, the supply of power to the first and second heaters 181, 182 increases and decreases over a period of time (i.e. the power supply is ramped up and down). In some embodiments, the supply of power to the first and second heaters 181, 182 may not be ramped and may be switched between the first, second and third predetermined amounts of power.

The blocks illustrated in the FIGS. 3 and 6 may represent steps in a method and/or sections of code in the computer program 24. The illustration of a particular order to the blocks does not necessarily imply that there is a required or preferred order for the blocks and the order and arrangement of the block may be varied. Furthermore, it may be possible for some blocks to be omitted.

Although examples of the present invention have been described in the preceding paragraphs, it should be appreciated that modifications to the examples given can be made without departing from the scope of the invention as claimed. For example, the power supplied to the heaters 18, 181, 182 may not be constant over time in the first, second and/or third zones 38, 40, 42 and may vary between a plurality of power levels.

Features described in the preceding description may be used in combinations other than the combinations explicitly described.

Although functions have been described with reference to certain features, those functions may be performable by other features whether described or not.

Although features have been described with reference to certain examples, those features may also be present in other examples whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. Printing apparatus comprising:
a controller to control supply of at least a first predetermined amount of power to a first heater while the first heater is moving through a print zone, and to control supply of at least a second predetermined amount of power to the first heater while the first heater is outside of the print zone, the second predetermined amount of power being less than the first predetermined amount of power.

2. Printing apparatus as claimed in claim 1, wherein the first heater has a first thermal energy output while being supplied with the first predetermined amount of power, and has a second thermal energy output while being supplied with the second predetermined amount of power, the second thermal energy output being less than the first thermal energy output.

3. Printing apparatus as claimed in claim 1, wherein the controller is arranged to control the supply of power to the first heater to change between the first predetermined amount of power and the second predetermined amount of power over a period of time.

4. Printing apparatus as claimed in claim 1, wherein the controller is arranged to control the supply of the first predetermined amount of power to the first heater while the first heater moves in a first direction through the print zone, and the controller is arranged to control the supply of at least a third predetermined amount of power to the first heater while the first heater moves in a second opposite direction through the print zone.

5. Printing apparatus as claimed in claim 1, further comprising a printer carriage include at least one print head and the first heater positioned adjacent the at least one print head.

6. Printing apparatus as claimed in claim 1, wherein the controller is arranged to control supply of at least a first predetermined amount of power to a second heater while the second heater is moving through a print zone, and to control supply of at least a second predetermined amount of power to the second heater while the second heater is outside of the print zone, the second predetermined amount of power being less than the first predetermined amount of power.

7. Printing apparatus as claimed in claim 6, wherein the controller is arranged to control the supply of the first predetermined amount of power to the first heater and to control the supply of at least a third predetermined amount of power to the second heater while the first and second heaters move in a first direction through the print zone, and the controller is arranged to control the supply of at least a third predetermined amount of power to the first heater and to control the supply of the first predetermined amount of power to the second heater while the first and second heaters move in a second opposite direction through the print zone.

8. Printing apparatus as claimed in claim 6, further comprising a printer carriage including at least one print head and the first heater being positioned adjacent a first end of at least one print head and the second heater being positioned adjacent a second opposite end of the at least one print head.

9. Printing apparatus as claimed in claim 1, wherein the power level of the second predetermined amount of power is selected so that heat energy from the first heater causes little or no damage to the printing apparatus.

10. A method of controlling printing apparatus, the method comprising:
controlling supply of at least a first predetermined amount of power to a first heater while the first heater is moving through a print zone; and
controlling supply of at least a second predetermined amount of power to the first heater while the first heater is outside of the print zone, the second predetermined amount of power being less than the first predetermined amount of power.

11. A method as claimed in claim 10, wherein the first predetermined amount of power is supplied to the first heater while the first heater moves in a first direction through the print zone, and at least a third predetermined amount of power is supplied to the first heater while the first heater moves in a second opposite direction through the print zone.

12. A method as claimed in claim 10, further comprising controlling supply of at least a first predetermined amount of power to a second heater while the second heater is moving through a print zone, and controlling supply of at least a second predetermined amount of power to the second heater while the second heater is outside of the print zone, the second predetermined amount of power being less than the first predetermined amount of power.

13. A method as claimed in claim 12, wherein the first predetermined amount of power is supplied to the first heater and at least a third predetermined amount of power is supplied to the second heater while the first and second heaters move in a first direction through the print zone, and wherein at least a third predetermined amount of power is supplied to the first heater and the first predetermined amount of power is supplied to the second heater while the first and second heaters move in a second opposite direction through the print zone.

14. A method as claimed in claim 10, wherein the power level of the second predetermined amount of power is selected so that heat energy from the first heater causes little or no damage to the printing apparatus.

15. A non-transitory computer-readable storage medium encoded with instructions that, when performed by a processor, cause performance of
controlling supply of at least a first predetermined amount of power to a first heater while the first heater is moving through a print zone; and
controlling supply of at least a second predetermined amount of power to the first heater while the first heater is outside of the print zone, the second predetermined amount of power being less than the first predetermined amount of power.
